(19) United States
(12) Patent Application Publication
(10) Pub. No.: US 2025/0086477 A1
(43) Pub. Date: Mar. 13, 2025

(54) METHOD AND APPARATUS WITH REINFORCEMENT-BASED CONTROL OF GENETIC ALGORITHM

(71) Applicant: Samsung Electronics Co., Ltd., Suwon-si (KR)

(72) Inventors: Hyung-Dal KWON, Suwon-si (KR); Youngmin OH, Suwon-si (KR); Doyun KIM, Suwon-si (KR); Yoonhyeok LEE, Suwon-si (KR); Bosun HWANG, Suwon-si (KR)

(73) Assignee: Samsung Electronics Co., Ltd., Suwon-si (KR)

(21) Appl. No.: 18/884,874

(22) Filed: Sep. 13, 2024

(30) Foreign Application Priority Data
Sep. 13, 2023 (KR) 10-2023-0122100

(51) Int. Cl. G06N 3/126; G06N 3/0985

(52) U.S. Cl. CPC G06N 3/126; G06N 3/0985

(57) ABSTRACT

A method is performed by one or more processors, and the method includes: receiving a problem definition for which an optimized solution is to be determined; executing a genetic algorithm to determine the optimized solution, the executing the genetic algorithm including iteratively performing, according to changing values of a control parameter, a genetic operation on a population of elements while evaluating elements of the population against the problem definition, the control parameter being a hyperparameter of the genetic operations; based on results of the respective iterations of the genetic operation to a neural network, generating, by a neural network, the values of the control parameter; and determining the optimized solution based on the iterations of the genetic operation as controlled, via the values of the control parameter, by the neural network.

### CROSS-REFERENCE TO RELATED APPLICATIONS

This application claims priority to and the benefit under 35 USC § 119(a) of Korean Patent Application No. 10-2023-0122100 filed in the Korean Intellectual Property Office on Sep. 13, 2023, the entire contents of which are incorporated herein by reference.

### BACKGROUND

### 1. Field

The present disclosure relates to a method and device for performing a genetic algorithm for problem solving through reinforcement learning, and a designing method of an electronic device using the genetic algorithm.

### 2. Description of Related Art

A genetic algorithm is a computational model analogous to biological evolution of the natural world and is a type of global optimization technique used to solve optimization problems. A genetic algorithm may be an in-parallel global search algorithm that mimics biological genetics of the natural world. A genetic algorithm may produce better solutions to solve a problem by forming possible solutions to the problem to be solved into a fixed structure and modifying the possible solutions little by little, iteratively favoring and propagating the better genetically-derived solutions. In other words, a genetic algorithm may simulate an evolutionary search for finding an answer x that optimizes some unknown function Y=f(x).

### SUMMARY

In one general aspect, a method for performing a genetic algorithm is performed by one or more processors executing instructions, and the method includes: receiving problem data indicating a problem to be solved by the genetic algorithm; determining, by an agent device of a reinforcement learning system, a state to be observed with respect to the genetic algorithm, and determining, by the agent device, a hyperparameter of the genetic algorithm using a neural network, the agent device including the neural network that determines the hyperparameter; in response to execution of the genetic algorithm based on the hyperparameter, receiving, by the agent device, reward determined based on a result of executing the genetic algorithm; updating, by the agent device, a parameter of the neural network based on the reward; and based on the updating of the parameter of the neural network, generating solution data including an optimized solution to the problem.

The determining of the state to be observed with respect to the genetic algorithm and determining of the parameter of the genetic algorithm may include: in response to a graph representing an electronic circuit being used for generating a population of elements for a start of the genetic algorithm, by the agent device determining, as the state to be observed, a number of nodes and edges of the graph, a ratio of the nodes and the edges, and/or a shape of the graph.

The method may further include: determining, by the agent device, a number of elements to be selected from the population as the hyperparameter of the genetic algorithm.

The state to be observed may include a first state to be observed in a crossover operation of the genetic algorithm and the hyperparameter of the genetic algorithm may include a hyperparameter for the crossover operation.

The hyperparameter for the crossover operation may include a position and/or a number of cut points of parent elements in the population.

The receiving of the reward determined based on the result of the genetic algorithm may include: receiving, by the agent device, a fitted value of a child element generated by the crossover operation as an observation result of a changed state of the genetic algorithm.

The fitted value of the child element may include a total wire length of the child element.

The hyperparameter of the genetic algorithm may include a mutation rate for selecting genes based on a random value allocated in a mutation operation of the genetic algorithm.

The reward may be determined based on a difference between an average fitted value of elements in a population used for the genetic algorithm and an average fitted value of child elements generated by execution of the genetic algorithm.

In another general aspect, an agent device of a reinforcement learning system includes: one or more processors; and a memory storing instructions configured to cause the one or more processors to perform a process including: determining a state to be observed with respect to a genetic algorithm and a hyperparameter to be used in executing the genetic algorithm, the hyperparameter determined using a neural network, and transmitting information on the state to be observed and the hyperparameter to a genetic algorithm (GA) processor that executes the genetic algorithm according to the parameter; receiving reward determined based on a result of the execution of the genetic algorithm, the reward received from the GA processor in response to the execution of the genetic algorithm by the genetic algorithm processor based on the hyperparameter; and updating a parameter of the neural network based on the reward.

The process may further include accessing a graph representing an electronic circuit, and based on the graph: the genetic algorithm determines the result by iteratively changing and evaluating a population of elements initialized according to the graph, wherein the state to be observed with respect to the genetic algorithm and the hyperparameter to be used in the genetic algorithm using the neural network is determine based on a number of nodes and edges of the graph, a ratio of the nodes and the edges, and/or a shape of the graph.

A number of elements to be selected from the population may be determined as the hyperparameter to be used in the genetic algorithm.

The hyperparameter to be used in the genetic algorithm may be used in a crossover operation of the genetic algorithm and the state to be observed may be related to the genetic algorithm.

The reward may be based on a fitted value of a child element generated by the crossover operation as an observation result of a changed state of the genetic algorithm.

The hyperparameter to be used in the genetic algorithm may be a mutation rate for selecting genes based on a random value allocated in a mutation operation of the genetic algorithm.

The reward may be determined based on a difference between an average fitted value of elements in a population used for the genetic algorithm and an average fitted value of child elements generated by execution of the genetic algorithm.

Determining of the state to be observed with respect to the genetic algorithm and the hyperparameter to be used in the genetic algorithm using the neural network may include determining a number or a ratio of blocks to be rearranged for local optimization of elements in a local optimization operation of the genetic algorithm as the hyperparameter.

In yet another general aspect, a method is performed by one or more processors, and the method includes: receiving a problem definition for which an optimized solution is to be determined; executing a genetic algorithm to determine the optimized solution, the executing the genetic algorithm including iteratively performing, according to changing values of a control parameter, a genetic operation on a population of elements while evaluating elements of the population against the problem definition, the control parameter being a hyperparameter of the genetic operations; based on results of the respective iterations of the genetic operation to a neural network, generating, by a neural network, the values of the control parameter; and determining the optimized solution based on the iterations of the genetic operation as controlled, via the values of the control parameter, by the neural network.

The control parameter may be updated based on a state of the population.

The problem definition may include a data structure defining a circuit, and the optimized may include an arrangement of components of the circuit that minimizes a wire length of the circuit.

Other features and aspects will be apparent from the following detailed description, the drawings, and the claims.

### BRIEF DESCRIPTION OF THE DRAWINGS

FIG. 1 illustrates a problem solving method according to one or more embodiments.

FIG. 2 illustrates a problem solving method using a genetic algorithm process according to one or more embodiments.

FIG. 3 illustrates a reinforcement learning method of a single agent device according to one or more embodiments.

FIG. 4 illustrates a reinforcement learning method of multiple agent devices according to one or more embodiments.

FIG. 5 illustrates a crossover method in the genetic algorithm process according to one or more embodiments.

FIG. 6 illustrates the crossover method in the genetic algorithm process according to one or more embodiments.

FIG. 7 illustrates a mutation method in the genetic algorithm process according to one or more embodiments.

FIG. 8 illustrates an example of the mutation method in the genetic algorithm process according to one or more embodiments.

FIG. 9 illustrates a local optimization method in the genetic algorithm process according to one or more embodiments.

FIG. 10 illustrates an example of the local optimization method in the genetic algorithm process according to one or more embodiments.

FIG. 11 illustrates a problem solving method through a problem solving system according to one or more embodiments.

FIG. 12 illustrates a neural network according to one or more embodiments.

FIG. 13 illustrates a problem solving system according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

An artificial intelligence (AI) model running on a neural network of the present disclosure may be a machine learning model that learns at least one task, and can be implemented as a computer program (instructions) executed by a processor. A task learned by an artificial intelligence model may refer to a task to be solved through machine learning or a task to be performed through machine learning. Artificial intelligence models can be implemented as computer programs (instructions) running on computing devices, downloaded over a network, or sold in product form. Alternatively, the artificial intelligence model can link with various devices through a network.

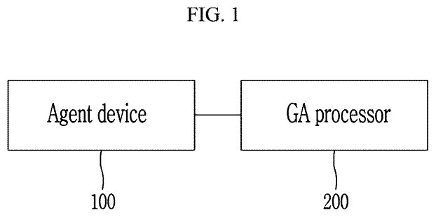

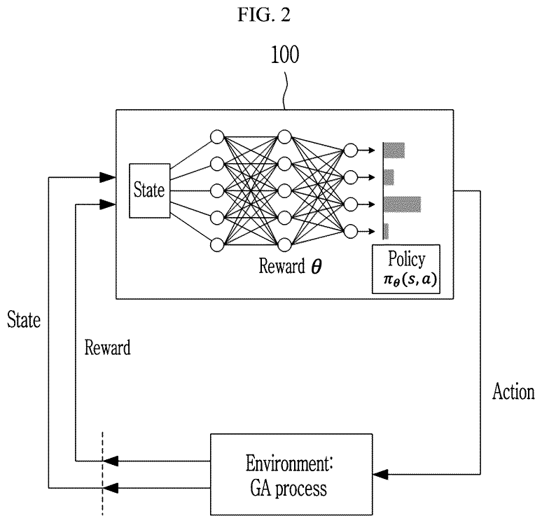

FIG. 1 illustrates a problem solving method according to one or more embodiments and FIG. 2 illustrates a problem solving method according to one or more embodiments. Generally, the problem solving method is centered on a genetic algorithm where a population of elements is repeatedly changed and tested according to a problem to be solved.

Referring to FIG. 1, a problem solving system may include an agent device 100 and a genetic algorithm (GA) processor 200. For general understanding, the agent device 100 may function as a kind of conductor or controller of the GA processor 200 while the GA processor 200 performs a GA to solve a problem, and the agent device 100 may be involved in the GA algorithm from its initiation and through iterations of the GA algorithm. Although the agent device 100 is referred to as a “device”, this term, as used herein, does not have a meaning, herein, that requires the agent and the GA algorithm to execute on different devices. That is, the GA algorithm may execute on the agent device, or it may execute on a separate device.

The agent device 100 may determine a state to be observed (e.g., one or more qualities of a population of elements) for each operation (e.g., an operation altering the population) of a GA process performed by the GA processor 200 and determine hyperparameters for each operation (or iteration) of the GA process. The hyperparameter may specifiy details of the GA process and the agent device 100 may determine the hyperparameter as an action of reinforcement learning. The agent device 100 may transmit information on the state to be observed and/or hyperparameters to the GA processor 200. The GA processor 200 may then perform the GA process using the hyperparameters and observe a corresponding change to the state from the agent device 100. The GA processor 200 may then provide the observation result and reward to the agent device 100. Then, the agent device 100 may update parameters and/or policy of a neural network based on the reward. The parameters of the neural network are the coefficients (e.g., weights and/or biases) of an AI model and they are updated by a learning process of the AI model. The observation result of the changed state may be used as an input to the neural network for the next GA process.

The GA processor 200 performs the GA process (e.g., a population update) according to the hyperparameters determined by the agent device 100 and observes corresponding changes in the state for each operation (or iteration) of the GA process and/or changes in the entire state of the GA process. The GA processor 200 may (i) monitor the state that needs to be observed based on information about the state to be observed that is received from the agent device 100 (i.e., observes how the population changes, as instructed by the agent device 100) and may (ii) transmit the observation result of the changed state to the agent device 100. In addition, the GA processor 200 may calculate reward based on the observation result and feed the calculated reward back to the agent device 100.

In some embodiments, the agent device 100 and the GA processor 200 each may include at least one or more of a CPU, a GPU, an NPU, a FPGA, and/or a DSP. In addition, the agent device 100 and the GA processor 200 may distribute tasks to at least one of CPU, GPU, NPU, FPGA, and/or DSP. The distributing may consider the time required for each operation of the GA process and the load on the CPU, GPU, NPU, FPGA, DSP, and/or the like. Each operation of the GA process may be distributed to at least one of the CPU, GPU, NPU, FPGA, and/or DSP; some operations may be performed in parallel. The problem solving system according to some embodiments may include a separate processor or agent device to distribute work between the agent device 100 and the GA processor 200.

In some embodiments, the observation results of respective changed states for the environment (e.g., the population) may be compressed by the neural network. The agent device 100 may perform reinforcement learning using the compressed observation results of the changed state. The neural network may include a variational autoencoder (VAE) for the compressing.

Referring to FIG. 2, when the state of the environment is input to the agent device 100, an action to be taken toward the environment may be determined by the agent device 100 from a policy regarding parameters of the agent's neural network (here, “policy” is used in the sense of reinforcement learning). The agent device 100 may also determine a state that needs to be observed of the GA process (environment) and provide information on the state to be observed to the GA processor 200.

When an action of agent device 100 is taken on the GA process: (i) the state of the GA process changes, (ii) the changed state may be observed by the GA processor 200, and (ii) observation of the changed state may be fed back to the agent device 100. In addition, the GA processor 200 may calculate reward (described later) based on the information on the state to be observed and the observation result of the changed state and feed the reward back to the agent device 100. The action of the agent device 100 may be determining of the hyperparameters of the GA process and transmitting the determined hyperparameters to the GA processor 200 (i.e., the agent may control the GA process based on the feedback from the GA processor, and the control may be via inferring values of the parameter used in the GA processor 200).

The GA process may be for determining a solution to a problem. For example, when a solution candidate to a problem is encoded as a set/population of elements, one element among the elements may be determined as the solution through the GA process, usually after the population has been altered over some number of generations of simulated genetic evolution.

In some embodiments, the problem that the problem solving system seeks to solve using the GA process may be, as an explanatory example, finding an arrangement (e.g., ordering) of physical blocks (e.g., circuits/chips responsible for pre-determined functions) in a pre-determination area of an electronic device in order to design the electronic device. For example, blocks may need to be arranged in a linear dimension (e.g., a row) in a peripheral area of a memory device. In other words, when blocks for controlling operations of a memory device (e.g., electronic components included in a controller) are to be placed in the peripheral area of the memory, the GA process may be used to find a physical arrangement of the blocks that minimizes a length of wire needed for connecting each component (i.e., the solution to the problem).

In some embodiments, the blocks may need to be arranged with an ordering in a linear dimension within the peripheral area of the memory. An ordering of the physical blocks may be encoded as a numeric string or a vector, where vector elements (or string characters) represent respectively corresponding physical blocks. In other words, the encoded numeric string or vector (population element, as described later) may represent an ordering of corresponding physical blocks (population elements). For example, if six blocks need to be arranged, an ordering of blocks (which may be a population element) may be encoded as a six character/element numeric string or vector, for example, [0,1,2,3,4,5], [0, 3,1,5,4,2], [2,0,5,3,4,1], etc.

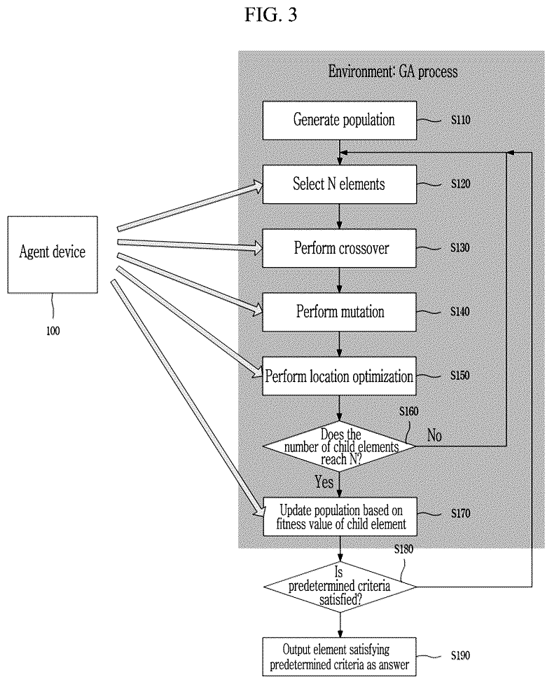

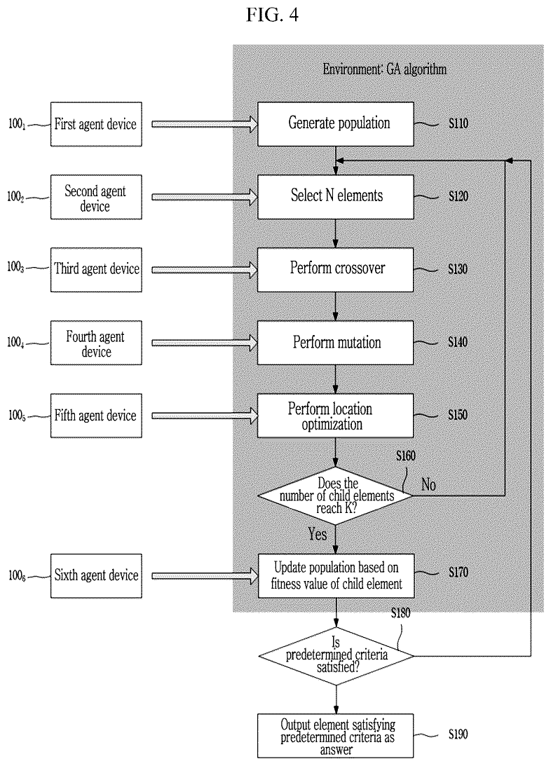

FIG. 3 illustrates a reinforcement learning method of a single agent device according to one or more embodiments. FIG. 4 illustrates a reinforcement learning method of multiple agent devices according to one or more embodiments.

Referring to FIG. 3 and FIG. 4, the agent device 100 (or agent devices 100₁ to 100ₙ) may determine a state (of the population) that is to be observed for each operation (or iteration) of the GA process and determine a hyperparameter for the operation of each GA process.

The agent device 100 of FIG. 3 (or the first agent device 100₁ of FIG. 4) may determine a state to be observed in a population generation operation S110 for generating an initial population of elements through population initialization. When n genes are included in one population element (e.g., six, as with the example above), the number of all potential unique elements for a given problem may be n!. Through the population initialization operation, a pre-determined number of elements (among the n! possible elements) may be included in the initial population. The number of elements included in the population may be a hyperparameter determined/controlled by the agent device 100.

The agent device 100 may: determine a state to be observed in a population generation operation (e.g., a statistical property of the population), determine hyperparameters of the population generation operation accordingly, and provide information on the state to be observed and the hyperparameters to the GA processor 200. Input/output data and/or internal data in the population generation operation may be the state to be observed.

For example, when a file representing a structure of an electronic circuit (e.g., a netlist file) or a graph representing an electronic circuit is input to the agent device 100 for the population generation operation of the GA process, the agent device 100 may determine the number of nodes and edges of the graph (i.e., a length of the element or the number of genes in the element), a ratio of the nodes and edges of the graph, and/or a shape of the graph as the state to be observed.

In some embodiments, elements in the population may each have a quality, and the state to be observed may include average quality, maximum quality, minimum quality, variance of quality, and/or histogram of the qualities of the elements in the population. For example, the quality of an element may be determined by a total wire length of nodes corresponding to the element. The shorter the wire length of the node arranged according to the gene order of an element, the higher the quality of the element.

In some embodiments, the elements to be included in the initial population may be generated through a depth first search (DFS) method and/or a breadth first search (BFS) method with each node of the graph (one node corresponds to one block) as a root node. The number of elements generated by the DFS method and/or BFS method may be equal to the number of blocks to be arranged in the peripheral area. To elaborate, as many elements as there are nodes (blocks) are generated by the DFS/BFS method, so that the optimal solution (that is, optimal element) can be found faster than finding the optimal element from randomly generated elements. When there are N nodes (blocks), there may be N!(N×N−1× . . . ×2×1) randomly generated elements, but DFS or BFS generates N elements, and the optimal element is determined among the N elements, so the optimal element can be found faster.

The agent device 100 of FIG. 3 (or a second agent device 100₂ of FIG. 4) may determine a hyperparameter for selecting N elements among the elements currently (e.g., initially, or as modified by genetic operations) included in the population (N is not the n (number of genes) mentioned above). The hyperparameter may be the number N of elements to be selected, and the agent device 100 (or the second agent device 100₂) may provide the hyperparameter to the GA processor 200. The providing of the hyperparameter may be done for each GA iteration because the agent device 100 updates parameters of the neural network for the reinforcement learning based on the reward calculated by the changed state and generates a new action using the updated neural network. At step S120, the GA processor 200 may select N elements from the population using an algorithm such as a roulette-wheel. Roulette selection is generally a stochastic selection method, where the probability for selection of an element is proportional to its fitness (e.g., how well a population element solves the problem). Fitness may be indicated by fitness values of the elements. When generating the initial population of elements, the GA processor 200 may also compute fitted values for the respective initial elements. Computation of fitted values for initial elements may be done as per the description below of computing fitted values of child elements. With the initial population of elements provided, the GA processor 200 may generate new/child elements from the initial population.

The GA processor 200 may generate a child element (e.g., for a new generation of the population) by applying a genetic operation (e.g., steps S130, S140, and/or S150) to a selected element (or elements, in the case of step S130). The agent device 100 (or third to sixth agent devices 100₃ to 100₆) may determine states to be observed in each genetic operation of the GA process and may determine hyperparameters for the genetic operation(s). The GA processor 200 may perform the genetic operation of the GA process using the hyperparameter determined by the agent device. For reference, new elements will be referred to as “child” elements, with the understanding that a child element may not be a product of two elements. In other words, “child element” refers to a new element, regardless of how it is derived.

The genetic operation(s) may include a crossover operation (S130), a mutation operation (S140), and a local optimization operation (S150). As will be seen, then, the GA processor 200 may determine a problem solution from child elements generated by the GA process.

In the crossover operation (S130), the GA processor 200 may generate a child element by performing an ordered crossover such as a partially matched crossover (PMX), which is applied to permutation problems, on genes within a pair of parent elements selected from the population.

In some embodiments, the state to be observed in the crossover operation may be input/output data and/or internal data of the crossover operation. The input data of the crossover operation may be a numeric string of parent elements, and the output data of the crossover operation may be a numeric string of a child element generated from the parent elements. The internal data of the crossover operation may be hyperparameters for crossover (e.g., position and/or number of cut points for crossover between elements). Then, the agent device may receive an observation result of the state from the GA processor 200.

In the mutation operation (S140), the GA processor 200 may generate a child element by randomly allocating a value between 0 and 1 to each gene of an element and performing a swap between genes allocated with a size smaller than a mutation rate.

In the local optimization operation (S150), the GA processor 200 may generate a child element by shifting a position of a gene in an element. For example, genes within the element of [0,1,2,3,4,5] may be shifted and locally optimized to the element [1,2,3,4,5,0].

The generating of a child element by any of the element-generation operations mentioned above may include the GA processor 200 calculating a fitted value of the child element by performing simulation on the problem to be solved through the GA process according to the solution represented by the child element. The fitted value of the new child element indicates how well the element solves/fits the solution.

In some embodiments, the fitted value of an element generated through the GA process may correspond to a length of wire of blocks to be placed in a peripheral area of an electronic device. For example, a child element with a relatively large fitted value may indicate that the arrangement order of blocks represented by the child element makes the total length of the wire relatively short. Alternatively, a child element with a relatively small fitted value may indicate that the arrangement order of blocks makes the total length of the wire relatively long. The wire length and value fit may instead be inversely proportional, depending on implementation. When the wire length of the blocks to be placed in the peripheral area is minimized, signal integrity and power integrity can be improved and the maximum clock frequency can be improved.

Then, the GA processor 200 may determine whether the fitted value of the new child element satisfies a predetermined criteria and terminate the GA process according to the determination if the new child element satisfies the predetermined criteria as the solution to the problem (S180, S190).

In some embodiments, when no child element has satisfied the predetermined criteria and K new elements have been generated (S160), the GA processor 200 may re-execute the GA process based on a state to be observed and/or hyperparameters determined by the agent device 100 and generate a new generation of elements. In some embodiments, it is a step in the GA process anywhere from the generation of the population to the generation and evaluation of a predetermined number K of child elements (S160). That is, when the solution is not determined from the child elements generated by one step of the GA process, the GA processor 200 may generate a new population and perform the GA process again.

Referring to FIG. 2, the GA processor 200 may update the population based on the fitted values of the child elements and the fitted values of the elements in the current population after performing one iteration (loop) of the GA process (S170). The GA processor 200 may replace less-fit existing elements with fitter child elements. Specifically, the GA processor 200 may replace an element in the population having a fitted value that is smaller than the fitted value of a new element. For example, when the fitted value of a child element is larger than the fitted value of any element in the population, the GA processor 200 may replace that element with the corresponding child element. That is, the child element with a larger fitted value is newly included in the population, and the newly included element, now being part of the population, may be sampled in the next iteration of the GA process.

Referring to FIG. 3, when the GA processor 200 performs the GA process for a predetermined number of iterations for a given problem to be solved, accumulated reward determined based on the fitted value of a new child element may be provided to the agent device 100. The agent device 100 may update the parameters and/or policy of the neural network to maximize reward or accumulated reward. The accumulated reward according to reinforcement learning can be described by a value function Q as shown in Equation 1 below.

$${Q}^{π} ( {s}_{t} , {a}_{t} ) := {𝔼}_{\begin{matrix}{s}_{t + 1 : ∞} \\ {a}_{t + 1 : ∞}\end{matrix}} , [ {\sum }_{l = 0}^{∞} {r}_{t + l} ] \qquad Equation 1$$

In Equation 1, aₜ denotes an action of the agent device 100 in a time step t, sₜ denotes a state of the GA process (an environment, in the reinforcement learning sense) in the time step t, and Q^{π}(sₜ, aₜ) denotes a value function regarding the action of the agent device 100 taken on the state of the environment in the time step t (i.e., the “reward” of the agent in reinforcement learning). The sum

$${\sum }_{l = 0}^{∞} {r}_{t + l}$$

of the reward after the time step t may be provided to the agent device 100.

In some embodiments, the reward provided to the agent device 100 may be determined based on a difference between fitted values of elements within the existing population of the GA process and fitted values of the child elements newly generated through the GA process. For example, reward may be determined based on a difference between the average fitted value of the child elements and the average fitted value of the elements in the population. Reward may be determined for every iteration of the GA process, and then reward accumulated while the GA process is performed the predetermined number of times may be provided to the agent device 100.

Referring to FIG. 4, the GA processor 200 may feed the observation results of the state to the agent devices 100₁ to 100ₙ after each operation of the GA process is completed. For example, when each operation of the GA process is completed, the GA processor 200 may calculate a fitted value of a new child element and feed the fitted value generated in each operation back to a corresponding one of the agent devices 100₁ to 100ₙ. Alternatively, the GA processor 200 may feed observation results of states of all operations back to the agent devices 100₁ to 100ₙ after one step of the GA process is terminated.

In some embodiments, the agent device 100 may update parameters and/or policies of its neural network (e.g., through backpropagation) to, for example, minimize the length of the wire formed by the blocks to be placed in the peripheral area based on (i) the reward and/or (ii) accumulated reward received from the GA processor 200.

As described above, the agent device 100 of the problem solving system according to some embodiments may determine a state to be observed for each operation of the GA process and transmit a hyperparameter for each operation to the GA processor 200, thereby the performance of the GA process can be optimized (through the neural network of the agent) and the solution to the problem can be accurately derived by the GA processor 200. Put another way, a reinforcement-based neural network may be used to evaluate the GA algorithm and exert learned influence on how the GA algorithm is performed, in the various ways noted above.

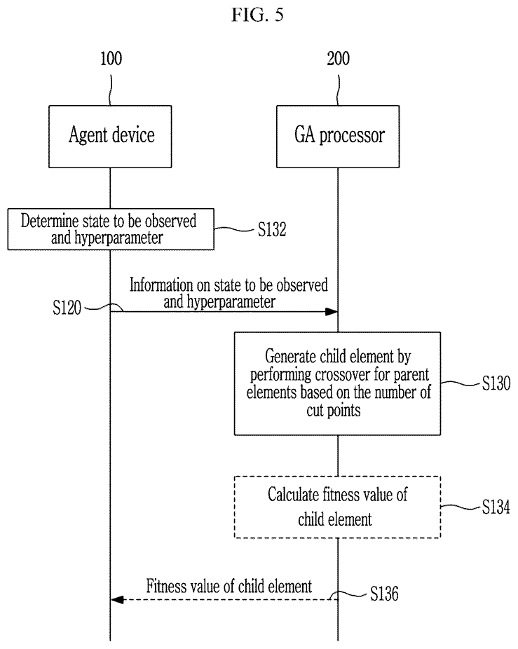

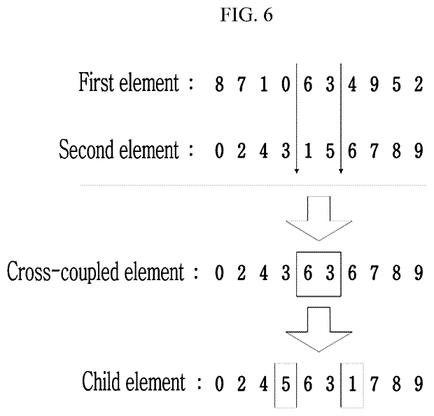

FIG. 5 illustrates a crossover method in the GA process according to one or more embodiments and FIG. 6 illustrates the crossover method in the GA process according to one or more embodiments. Here, the crossover method is shown as it interacts (and is controlled by) an agent device 100. The crossover method corresponds to the crossover operation of step S130. While the crossover method is described with reference to FIGS. 5 and 6, the explanation of the agent interaction/control is generally similar to the later explanations of mutation and location optimization operations (steps S140 and S150). Furthermore, while agent device 100 is described as interacting with the crossover method, the third agent device 100₃ of FIG. 4 may interact instead (in the following description, the agent device 100 is representative of either agent device). However, in the case of other GA methods such as mutation and location optimization, the fourth and fifth agent devices 100₄ and 100₅ may be used instead of the agent device 100.

Referring to FIG. 5, the agent device 100 may determine a state to be observed in the crossover operation and a hyperparameter for the crossover operation (S110). As noted earlier, the crossover operation may be an operation that mixes two parent elements of the GA to generate a generally better child element (such is not guaranteed, but is the general trend of the GA).

In some embodiments, the state to be observed in the crossover operation may be the input/output data and/or internal data of the crossover operation. The input data of the crossover operation may be numeric strings (i.e., genetic codes) of the respective parent elements or fitted values of the respective parent elements. In addition, the output data output from the crossover operation may be a numeric string (i.e., genetic code) of the new child element (formed by the crossover operation) or a fitted value of the new child element. The internal data of the crossover operation may be hyperparameters for performing crossover (e.g., position and/or number of cut points for crossover between elements). After that, the agent device 100 may receive the observation result of the state from the GA processor 200. To summarize, the agent device, through reinforcement learning, may control parameters of the crossover operation.

The agent device 100 may transmit the hyperparameter for the crossover to the GA processor 200 or transmit the hyperparameter for another GA process near the crossover to the GA processor 200.

In some embodiments, the agent device 100 may transmit information on the state to be observed in the crossover operation and/or the hyperparameter for the crossover to the GA processor 200 (S132). In some embodiments, the hyperparameters for crossover may include the position and/or number of cut points for crossover between parent elements.

The GA processor 200 may perform a crossover operation based on hyperparameters transmitted from the agent device 100 (S130). In some embodiments, the GA processor 200 may generate child elements by cross-coupling parent elements based on the position and/or number of cut points.

Referring to FIG. 6, in the GA processor 200 performing the shown example of a crossover operation, two cut points are determined by the agent device 100, and the position of the cut point may be determined between the fourth and fifth genes of the element and between the sixth and seventh genes of the element by the agent device 100. Accordingly, the GA processor 200 may cross-couple the fifth and sixth genes of the first element, the first to fourth genes and the seventh to tenth genes of the second element based on the position and number of cut points transmitted from the agent device 100. Since gene 3 and gene 6 are duplicated in the cross-coupled element in FIG. 6, the GA processor 200 may replace the duplicated gene with gene 1 and gene 5 deleted by cross-coupling.

In some embodiments, the GA processor 200 may feed the state changed by the crossover operation back to the agent device 100.

Referring to FIG. 5, the GA processor 200 may calculate the fitted value (e.g., total wire length (TWL)) of a child element generated through the crossover (S134), and may feed the calculated fitted value of the child element back to the agent device 100 (S136).

The agent device 100 may receive the feedback from the GA processor 200 as the observation result of the state and reward and update the parameters (e.g., weights) of its neural network based on the reward. The observation result of the state may be inputted to the neural network to determine/infer the next action of the agent device 100; the next action of the agent device 100 may be determined according to the policy changed by the updated parameter (here, “policy” has the meaning used in reinforcement learning). In addition, the next action of the agent device 100 may be used as the hyperparameter for the next crossover operation of the GA processor 200.

Referring to FIG. 6, in the case of the illustrative circuit problem, the GA processor 200 may calculate the TWL of the child element [0,2,4,5,6,3,1,7,8,9] as a fitted value and feed the TWL of the child element back to the agent device 100. When the TWLs of the respective parent elements are in the previous state, the TWL of the child element may be an observation result of the state of the environment. A difference between the TWLs of the parent elements and the TWL of the child element may be transmitted as the reward to the agent device 100, and the agent device 100 may update the parameters and/or policy of its neural network to determine the next action based on the reward.

Alternatively, the GA processor 200 may feed the fitted value of the child element that is finally output back to the agent device 100 after the GA process is terminated. The GA processor 200 may feed the average, a total, and/or a change amount of the TWL of the final child element back to the agent device 100 as the reward.

When there is one agent device 100, the agent device 100 may receive a fitted value of the final child element as feedback and update the parameters and/or policies of its neural network while comprehensively considering actions with respect to the crossover and actions with respect to other operations of the GA process. In the case of the agent devices 100₁ to 100ₙ transmitting a hyperparameter to the GA processor 200, one of those agent devices (100₁ to 100ₙ) may update the parameters and/or policies of its neural network through mutual ensemble reinforcement learning (between the agent devices 100₁ to 100ₙ).

As described above, the agent device 100 according to some embodiments transmits the hyperparameter for the crossover as the reinforcement learning action to the GA processor 200 and changes the policy of the reinforcement learning based on a changed state according to the action, thereby optimizing the performance of the GA process for problem solving.

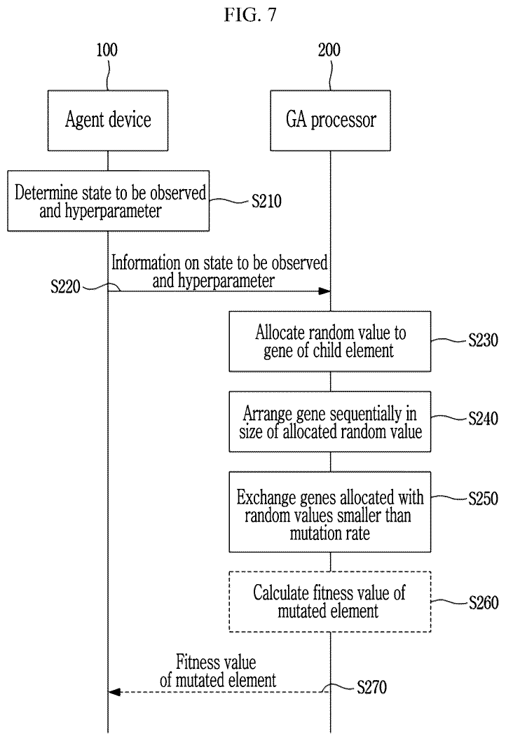

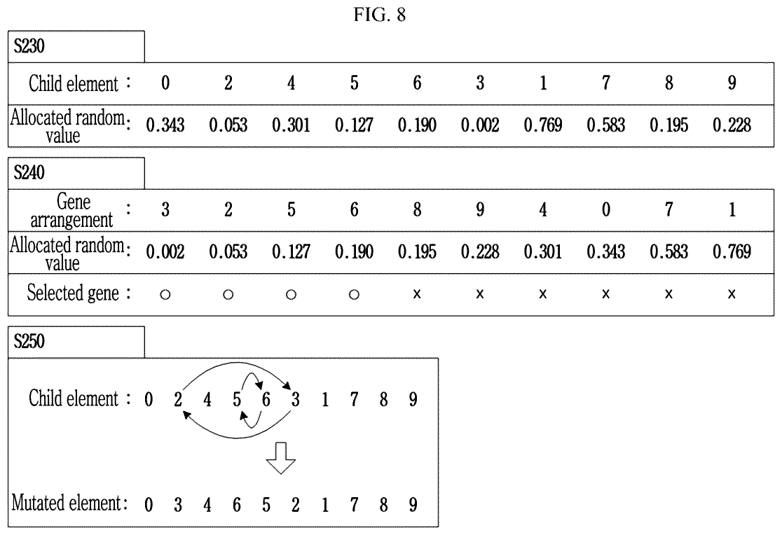

FIG. 7 illustrates a mutation method in the GA process according to one or more embodiments and FIG. 8 illustrates an example of the mutation method in the GA process according to one or more embodiments.

Referring to FIG. 7, an agent device 100 according to some embodiments may determine a state to be observed in the mutation operation (S210). In some embodiments, the state to be observed in the mutation operation may be input/output data and/or internal data of the mutation operation. The input data of the mutation operation may be a numeric string of a child element and the output data output from the mutation operation may be a numeric string of a mutated element (the child element). The internal data of the mutation operation may be a hyperparameter (e.g., a mutation rate for element mutation or the number of elements to be mutated) for mutation of the element. Then, the agent device 100 may receive an observation result of the state from the GA processor 200.

The agent device 100 may be the agent device 100 of FIG. 3 or the fourth agent device 100₄ of FIG. 4. For description, the agent device 100 will be referred to as representative of either agent device. The agent device 100 of FIG. 3 or the fourth agent device 100₄ of FIG. 4 may transmit the hyperparameter for the mutation to the GA processor 200 or may transmit a hyperparameter for another GA process around the mutation operation to the GA processor 200.

In some embodiments, the agent device 100 may transmit the hyperparameter for the mutation operation to the GA processor 200 (S220). The hyperparameter for the mutation may include a mutation rate for the mutation of elements, for example.

The GA processor 200 may perform the mutation operation based on the hyperparameter transmitted from the agent device 100. In some embodiments, the GA processor 200 may select genes in the element based on the mutation rate and generate a mutated element (a new child element) through exchanges between selected genes.

In some embodiments, the GA processor 200 may allocate a random value to each gene of a child element where the crossover operation is applied (S230) and arrange the genes sequentially in size of the allocated random value (S240). The random value may be any real number between 0 and 1.

Referring to the mutation example shown in FIG. 8, random values of 0.343, 0.053, 0.301, 0.127, 0.190, 0.002, 0.769, 0.583, 0.195, and 0.228 may be respectively allocated to the child elements [0,2,4,5,6,3,1,7,8,9]. When the genes are arranged in order of sizes of the allocated random values, the elements become [3, 2, 5, 6, 8, 9, 4, 0, 7, 1].

When the mutation rate transmitted as the hyperparameter from the agent device 100 is 0.15, the GA processor 200 may perform mutation on gene 3, gene 2, and gene 5 to which random values less than 0.15 are allocated. In some embodiments, the mutation may be carried out through an exchange between two genes, and therefore the GA processor 200 may determine a gene with a smallest random value among genes allocated with random values exceeding the mutation rate as an additional mutation target. In FIG. 8, the additional mutation target is gene 6.

The GA processor 200 may exchange (i.e., mutual change of gene positions) genes allocated with random values that are smaller than the mutation rate (S250). Referring to FIG. 8, the GA processor 200 may exchange gene 3 and gene 2 and exchange gene 5 and gene 6 in the child elements. As the GA processor 200 performs the mutation operation, the elements may be mutated to [0,3,4,6,5,2,1,7,8,9]

In some embodiments, the GA processor 200 may feed a state changed by the mutation operation back to the agent device 100. Referring to FIG. 7, the GA processor 200 may calculate a fitted value (e.g., TWL) of the mutated elements (S260) and may feed the calculated fitted value back to the agent device 100 (S270).

The agent device 100 may receive the feedback from the GA processor 200 as an observation result of the state and reward and update the parameters (e.g., weights) of its neural network based on the reward. The observation result of the state may be inputted to the neural network which then determines/infers the next action of the agent device 100; the next action may be determined according to the agent device's policy as changed by the updated parameter. In addition, the next action of the agent device 100 may be used as the hyperparameter for the next mutation operation of the GA processor 200.

Referring to FIG. 8, the GA processor 200 may calculate the TWL of the mutated genes of the child element [0,3,4,6,5,2,1,7,8,9] as the fitted value and feed the TWL of the mutated element back to the agent device 100. When the TWL of the child element is in the previous state, the TWL of the mutated element may be an observation result of the state of the environment. A difference between the TWL of the child element and the TWL of the mutated element may be transmitted as the reward to the agent device 100, and the agent device 100 may update the parameters and/or policy of its neural network to determine the next action based on the reward.

Alternatively, the GA processor 200 may feed the fitted values of the child elements that are finally output back to the agent device 100 after the GA process is terminated. The GA processor 200 may feed a total and/or a change amount of the TWL of the final child elements back to the agent device 100 as the reward.

When there is one agent device 100, the agent device 100 may receive the fitted value of the final child element as the feedback and update the parameters and/or policies of its neural network while comprehensively considering actions with respect to the mutation operation and actions with respect to other operations of the GA process. In the case of multiple agent devices 100₁ to 100ₙ, the agents may transmit a hyperparameter to the GA processor 200 and update the parameters and/or policies through the mutual ensemble reinforcement learning between themselves.

As described above, the agent device 100 according to some embodiments transmits the hyperparameter for the mutation process as the action of the reinforcement learning to the GA processor 200 and changes the policy of the reinforcement learning based on a changed state according to the action, thereby maximizing the performance of the GA process for problem solving.

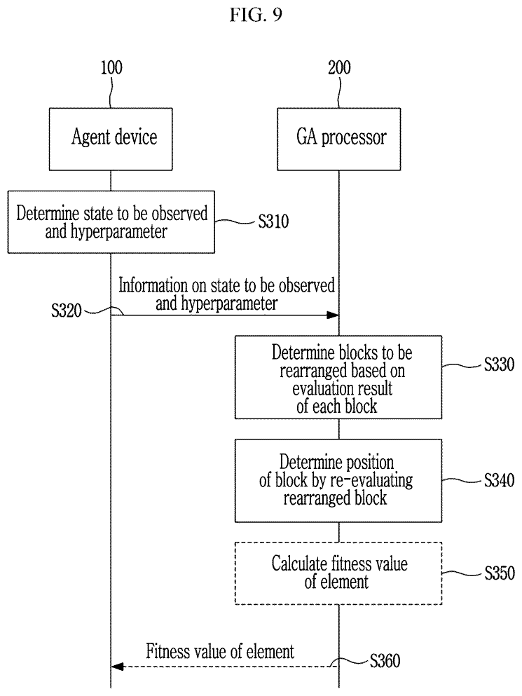

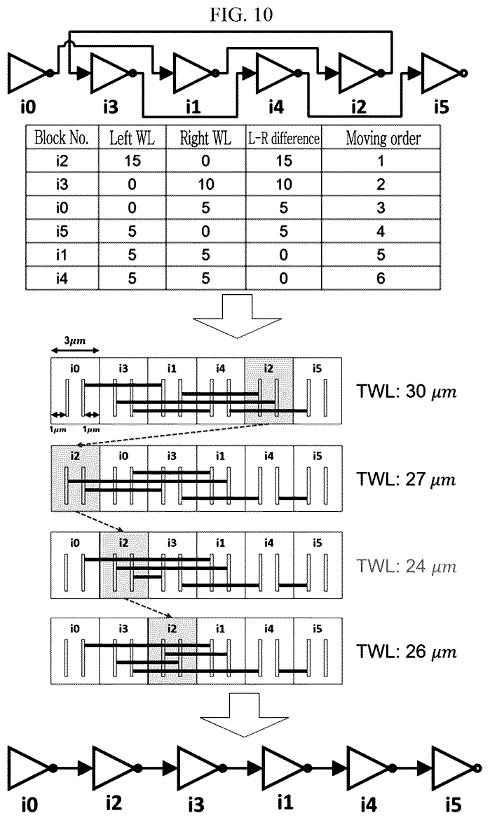

FIG. 9 illustrates a local optimization method in the GA process according to one or more embodiments and FIG. 10 illustrates an example of the local optimization method in the GA process according to one or more embodiments.

Referring to FIG. 9, an agent device 100 according to some embodiments may determine a state to be observed in the local optimization operation (S310). In some embodiments, the state to be observed in the local optimization operation may be input/output data or internal data of the local optimization operation. Input data of the local optimization operation may be a numeric string of the new child element (computed by the mutation) or a block corresponding to the mutated element, and an output from the local optimization operation may be a numeric string or block of a locally optimized element (e.g., a block ordering). As per FIGS. 3 and 4, an input to the local optimization block may be an output from the mutation block. Internal data of the local optimization operation may be a hyperparameter for local optimization of the elements (e.g., the number or ratio of blocks to be rearranged for the local optimization). Then, the agent device 100 may receive an observation result of a state from the GA processor 200.

The agent device 100 may instead be the fifth agent device 100₅ of FIG. 4. The agent device 100 of FIG. 3 or the fifth agent device 100₅ of FIG. 4 may transmit the hyperparameter for local optimization to the GA processor 200 or may transmit a hyperparameter for another GA process near the local optimization operation to the GA processor 200.

In some embodiments, the agent device 100 may transmit the hyperparameter for local optimization to the GA processor 200 (S320). In some embodiments, the hyperparameter for the local optimization may include the number/ratio of blocks to be rearranged for local optimization. For example, when it is (experimentally) determined that the performance of local optimization can be maximized when 40% of the blocks of an element are rearranged, the agent device 100 may transmit a ratio of blocks to be rearranged of 40% to the GA processor 200 as the hyperparameter.

The GA processor 200 may perform the local optimization operation based on the hyperparameters transmitted from the agent device 100. In some embodiments, the GA processor 200 may determine the blocks to be rearranged based on the TWL of each block of the element and re-calculate the TWL of each block by rearranging the determined blocks, thereby performing the local optimization operation.

In some embodiments, the GA processor 200 may determine a block to be rearranged based on an evaluation result of each block of the mutated element (S330) and determine a position of the block by rearranging and re-evaluating the determined block (S340). For example, the GA processor 200 may determine a block with a relatively large TWL as the block to be rearranged based on the TWL of each block. When the number of blocks to be rearranged is 1 (hyperparameter), the GA processor 200 may rearrange the block with the largest TWL and re-evaluate the TWL.

Referring to FIG. 10, among blocks of the element, the TWL of block i2 (left WL 15+right WL 15=30) is the largest, and therefore the GA processor 200 may re-calculate a TWL by rearranging block i2. The initial TWL of block i2 is 30 μm, but after the rearrangement, the TWL may be re-evaluated to 27 μm, 24 μm, and 26 μm. Since the position of block i2 that minimizes the TWL is between block i0 and block i3, the GA processor 200 may rearrange the order of blocks as i0, i2, i3, i1, i4, and i5.

In some embodiments, the GA processor 200 may feed the state changed by local optimization operation back to the agent device 100. Referring to FIG. 9, the GA processor 200 may calculate the fitted value (e.g., TWL) of the locally optimized element (S350) and feed the calculated fitted value back to the agent device 100 (S360).

The agent device 100 may receive the feedback from the GA process 200 as an observation result of a state and reward and may update parameters of the neural network based on the reward. The observation result of the state may be an input of the neural network to determine the next action of the agent device 100, and the next action of the agent device 100 may be determined according to the policy changed by the updated parameter. In addition, the next action of the agent device 100 may be used as the hyperparameter for the next local optimization operation of the GA processor 200.

Referring to FIG. 10, the GA processor 200 may calculate the TWL of a block [i0, i2, i3, i1, i4, i5] of the locally optimized element as the fitted value and may feed the TWL of the locally optimized element back to the agent device 100. When the TWL of the locally optimized element is in the previous state, the TWL of the locally optimized element may be an observation result of the state of the environment. A difference between the TWL of the original element and the TWL of the locally optimized its locally optimized child element may be transmitted to the agent device 100 as the reward, and the agent device 100 may update the parameters and/or policy of the neural network to determine the next action based on the reward.

Alternatively, the GA processor 200 may feed the fitted values of the child elements that are finally output after the GA algorithm is terminated, back to the agent device 100. The GA processor 200 may feed an average, a total, and/or a change amount of the TWL of the final child elements back to the agent device 100 as the reward.

When there is one agent device 100, the agent device 100 may receive the fitted value of the final child element as the feedback, and update the parameters and/or policies of the neural network while comprehensively considering actions with respect to the local optimization operation and actions with respect to other operations of the GA process. In the case of the multiple agent devices 100₁ to 100ₙ, the agent devices transmit a hyperparameter to the GA processor 200, agent devices 100₁ to 100ₙ may update the parameters and/or policies through mutual ensemble reinforcement learning between themselves.

As described above, the agent device 100 may transmit the hyperparameter for the local optimization operation as the action of the reinforcement learning to the GA processor 200 and changes the policy of the reinforcement learning based on a changed state according to the action, thereby optimizing the performance of the GA process for problem solving.

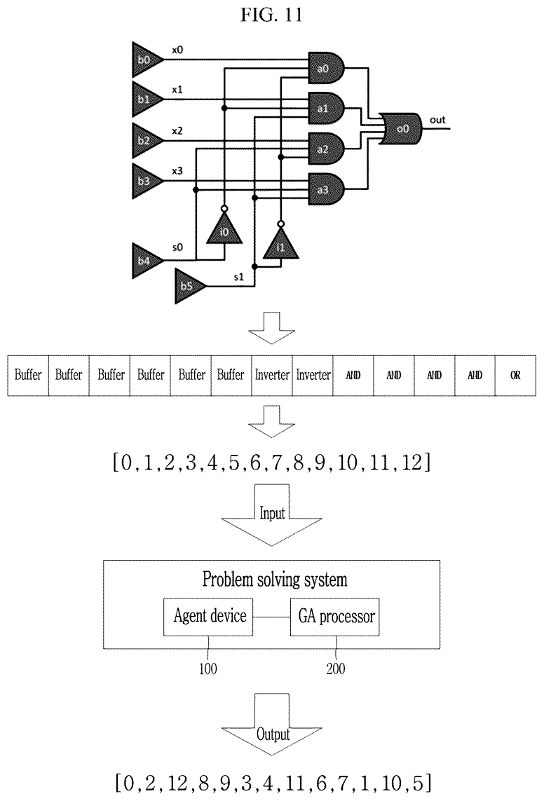

FIG. 11 illustrates a problem solving method according to one or more embodiments.

In some embodiments, a problem solving system may be used to optimize one-dimensional alignment of blocks (a buffer, an inverter, an AND gate, an OR gate, and the like) in the peripheral area of a memory semiconductor (e.g., a DRAM, a FLASH, an SSD, a CIS, a DDI, an SoC, a Smart Card, an MCU, and the like).

Referring to FIG. 11, when six buffers, two inverters, four AND gates, and one OR gate are to be arranged at the peripheral area of the memory, the arrangement order of each block may be encoded as a numeric string or vector as shown in Equation 2 below.

$$[ 0 , 1 , 2 , 3 , 4 , 5 , 6 , 7 , 8 , 9 , 10 , 11 , 12 ] \qquad Equation 2$$

When the numeric string or vector regarding the arrangement order of blocks is input to the problem solving system, the problem solving system may generate a population regarding the arrangement order of blocks, and the GA process may be used to output a solution to the problem derived from the generated population.

In some embodiments, the agent device 100 may perform reinforcement learning to take action for each operation of the GA process and receive the observation result of the state of at least one operation of the GA process and the corresponding reward from the GA processor 200.

The GA processor 200 may perform the GA process based on hyperparameters provided by an action of the agent device 100 and may feed back to the agent device 100 an observation result of a state changed according to the performance result of the GA process.

Then, based on fitted values calculated through simulation of final child elements determined by the GA process, one child element among the child elements may be output as the solution to the problem. The child element, which is the solution to the problem, may indicate the arrangement ordering of blocks that minimizes the TWL connecting blocks. The solution of the problem exemplarily shown in FIG. 11 is [0,2,12,8,9,3,4,11,6,7,1,10,5].

As described, the agent device 100 of the problem solving system according to some embodiments can provide hyperparameters for each operation of the GA process to the GA processor 200 by performing reinforcement learning using its neural network and may update/learn the parameters (e.g., weights) and/or policies of its neural network to determine better operation based on the feedback (i.e., observation results of state changes).

Through the reinforcement learning of the agent device 100, the performance of the GA process can be improved, and the solution to the problem (e.g., the arrangement order of blocks to be placed in a specific region of the memory) can be quickly output.

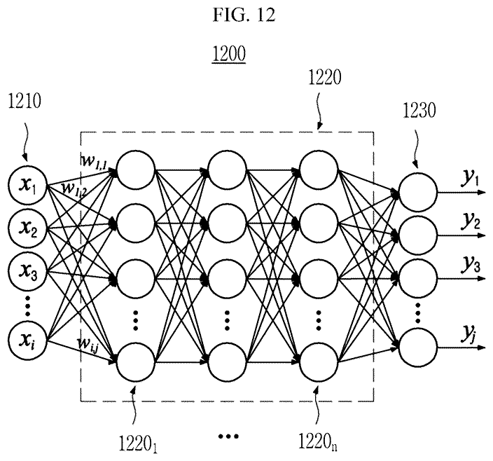

FIG. 12 illustrates a neural network according to one or more embodiments.

Referring to FIG. 12, a neural network (NN) 1200 according to some embodiments may include an input layer 1210, a hidden layer 1220, and an output layer 1230. The input layer 1210, the hidden layer 1220, and the output layer 1230 each includes a respective set of nodes, and strengths of connections between nodes of adjoining layers may be in the form of a weight value (weight connection). The nodes included in the input layer 1210, the hidden layer 1220, and the output layer 1230 may be fully connected to each other. In some embodiments, the number of parameters (weight value and bias) may be equal to the number of weight connections in the neural network 1200. A variety of neural network architectures may be used, and reinforcement learning-based networks may be readily adapted for the uses described above.

The input layer 1210 may include input nodes x₁ to xᵢ, and the number of input nodes x₁ to xᵢ may correspond to the number of independent input variables. For training of the neural network 1200, a training dataset is input to the input layer 1210, and when a test dataset is input to the input layer 1210 of the trained neural network 1200, an inference result may be output from the output layer 1230 of the trained neural network 1200. In some embodiments, the input layer 1210 may have a structure suitable for processing a large-scale input.

The hidden layer 1220 may be disposed between the input layer 1210 and the output layer 1230, and may include one or more hidden layers 1220₁ to 1220ₙ. The output layer 1230 may include one or more output nodes y₁ to yⱼ. An activation function may be used in the hidden layer 1220 and the output layer 1230. In some embodiments, the neural network 1200 may be learned by adjusting weight values of nodes included in the hidden layer(s).

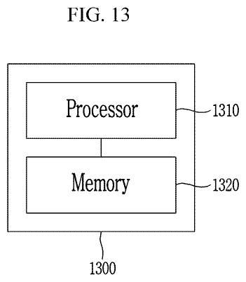

FIG. 13 illustrates a problem solving system according to one or more embodiments.

A problem solving system according to another embodiment may be implemented with a computer system, for example, a computer readable medium. Referring to FIG. 13, a computer system 1300 includes at least one processor 1310 and a memory 1320. The memory 1320 may be connected with the processor 1310 and store various information for driving the processor 1310 or at least one program executed by the processor 1310. In addition, the memory 1320 may store instructions configured to cause the at least one processor perform a process comprising the steps and/or methods described above.

The processor 1310 may implement a function, a process, or a method proposed in the embodiment. The operation of the computer system 1300 according to the embodiment may be implemented by the processor 1310. The processor 1310 is representative of one or more processors, which may include a GPU, a CPU, or the like. When the operation of the computer system 1300 is implemented by at least one processor 1310, each task may be divided among the at least one processor 1310 according to a load of each task. For example, when one processor is a CPU, the other processor may be one of a GPU, an NPU, an FPGA, and a DSP.

The memory 1320 may be positioned inside or outside the processor 1310, and the memory 1320 may be connected to the processor 1320 through various known means. The memory is various forms of volatile or non-volatile storage media, and, for example, the memory may include a read-only memory (ROM) or a random access memory (RAM), but is not a signal per se.

Meanwhile, the embodiments are not only implemented through the devices and/or methods described hereinabove, but may also be implemented through a program (instructions) that realizes a function corresponding to the configuration of the embodiments or a recording medium on which the program is recorded, and such an implementation can be readily implemented by anyone skilled in the art from the description of the embodiments described above. Specifically, methods (e.g., image preprocessing methods, etc.) according to the embodiment may be implemented by forming source code according to the description above, which can be compiled into the form of program instructions that when executed by one or more processors cause the same to perform any of the operations described herein. The instructions can be recorded on a computer-readable medium. The computer-readable medium may include the program instructions, data files, data structures, and the like, singly or in combination. The program instructions recorded on the computer-readable medium may be specially designed and configured for the embodiment, or may be known and usable by those skilled in the art of computer software. The computer-readable recording medium may include a hardware device configured to store and execute program instructions. For example, the computer-readable recording medium includes a magnetic medium such as a hard disk, a floppy disk, and a magnetic tape, an optical medium such as a CD-ROM, a DVD, a magneto-optical medium such as a floptical disk, a ROM, a RAM, a flash memory, and the like

A program's instructions may include not only a machine language code such as that created by a compiler, but also a high-level language code that can be executed by a computer through an interpreter, intermediate code, and the like.

the following claims also fall within the scope of the rights of the present disclosure.

The computing apparatuses, the electronic devices, the processors, the memories, the displays, the neural networks, the information output system and hardware, the storage devices, and other apparatuses, devices, units, modules, and components described herein with respect to FIGS. 1-13 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-13 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method for performing a genetic algorithm, the method performed by one or more processors executing instructions, the method comprising:
receiving problem data indicating a problem to be solved by the genetic algorithm;
determining, by an agent device of a reinforcement learning system, a state to be observed with respect to the genetic algorithm, and determining, by the agent device, a hyperparameter of the genetic algorithm using a neural network, the agent device comprising the neural network that determines the hyperparameter;
in response to execution of the genetic algorithm based on the hyperparameter, receiving, by the agent device, reward determined based on a result of executing the genetic algorithm;
updating, by the agent device, a parameter of the neural network based on the reward; and
based on the updating of the parameter of the neural network, generating solution data comprising an optimized solution to the problem.

2. The method of claim 1, wherein the determining of the state to be observed with respect to the genetic algorithm and determining of the hyperparameter of the genetic algorithm comprise:
In response to a graph representing an electronic circuit being used for generating a population of elements for a start of the genetic algorithm, by the agent device determining, as the state to be observed, a number of nodes and edges of the graph, a ratio of the nodes and the edges, and/or a shape of the graph.

3. The method of claim 2, further comprising:
determining, by the agent device, a number of elements to be selected from the population as the hyperparameter of the genetic algorithm.

4. The method of claim 1, wherein the state to be observed comprises a first state to be observed in a crossover operation of the genetic algorithm and the hyperparameter of the genetic algorithm comprises a hyperparameter for the crossover operation.

5. The method of claim 4, wherein the hyperparameter for the crossover operation comprises a position and/or a number of cut points of parent elements in the population.

6. The method of claim 5, wherein the receiving of the reward determined based on the result of the genetic algorithm comprises:
receiving, by the agent device, a fitted value of a child element generated by the crossover operation as an observation result of a changed state of the genetic algorithm.

7. The method of claim 6, wherein the fitted value of the child element comprises a total wire length of the child element.

8. The method of claim 1, wherein the hyperparameter of the genetic algorithm comprises a mutation rate for selecting genes based on a random value allocated in a mutation operation of the genetic algorithm.

9. The method of claim 1, wherein the reward is determined based on a difference between an average fitted value of elements in a population used for the genetic algorithm and an average fitted value of child elements generated by execution of the genetic algorithm.

10. An agent device of a reinforcement learning system, the agent device comprising one or more processors; and
a memory storing instructions configured to cause the one or more processors to perform a process comprising:
determining a state to be observed with respect to a genetic algorithm and a hyperparameter to be used in executing the genetic algorithm, the hyperparameter determined using a neural network, and transmitting information on the state to be observed and the hyperparameter to a genetic algorithm (GA) processor that executes the genetic algorithm according to the hyperparameter;
receiving reward determined based on a result of the execution of the genetic algorithm, the reward received from the GA processor in response to the execution of the genetic algorithm by the genetic algorithm processor based on the hyperparameter; and
updating a parameter of the neural network based on the reward.

11. The device of claim 10, the process further comprising accessing a graph representing an electronic circuit, and based on the graph:
the genetic algorithm determines the result by iteratively changing and evaluating a population of elements initialized according to the graph, wherein the state to be observed with respect to the genetic algorithm and the hyperparameter to be used in the genetic algorithm using the neural network is determine based on a number of nodes and edges of the graph, a ratio of the nodes and the edges, and/or a shape of the graph.

12. The device of claim 11, wherein a number of elements to be selected from the population is determined as the hyperparameter to be used in the genetic algorithm.

13. The device of claim 10, wherein the hyperparameter to be used in the genetic algorithm is used in a crossover operation of the genetic algorithm and the state to be observed is related to the genetic algorithm.

14. The device of claim 13, wherein the reward is based on a fitted value of a child element generated by the crossover operation as an observation result of a changed state of the genetic algorithm.

15. The device of claim 10, wherein the hyperparameter to be used in the genetic algorithm is a mutation rate for selecting genes based on a random value allocated in a mutation operation of the genetic algorithm.

16. The device of claim 10, wherein
the reward is determined based on a difference between an average fitted value of elements in a population used for the genetic algorithm and an average fitted value of child elements generated by execution of the genetic algorithm.

17. The device of claim 10, wherein
determining of the state to be observed with respect to the genetic algorithm and the hyperparameter to be used in the genetic algorithm using the neural network comprises
determining a number or a ratio of blocks to be rearranged for local optimization of elements in a local optimization operation of the genetic algorithm as the hyperparameter.

18. A method performed by one or more processors, the method comprising:
receiving a problem definition for which an optimized solution is to be determined;
executing a genetic algorithm to determine the optimized solution, the executing the genetic algorithm comprising iteratively performing, according to changing values of a control parameter, a genetic operation on a population of elements while evaluating elements of the population against the problem definition, the control parameter being a hyperparameter of the genetic operations;
based on results of the respective iterations of the genetic operation to a neural network, generating, by a neural network, the values of the control parameter; and
determining the optimized solution based on the iterations of the genetic operation as controlled, via the values of the control parameter, by the neural network.

19. The method of claim 18, wherein the control parameter are updated based on a state of the population.

20. The method of claim 18, wherein the problem definition comprises a data structure defining a circuit, and wherein the optimized comprises an arrangement of components of the circuit that minimizes a wire length of the circuit.
